(19) United States
(12) Patent Application Publication
(10) Pub. No.: US 2002/0075619 A1
(43) Pub. Date: Jun. 20, 2002

(54) Overvoltage protection circuit`

(76) Inventors: Michael John Maytum, Bedford (GB); Steven Wilton Byatt, Bromham (GB)

Correspondence Address: Howard J. Klein, Klein & Szekeres, LLP, Ste. 700, 4199 Campus Dr., Irvine, CA, 92612, US

(21) Appl. No.: 10/024,402

(22) Filed: Dec. 18, 2001

(30) Foreign Application Priority Data
Dec. 20, 2000 (GB) UK 0030992.2

(51) Int. Cl. H02H 3/20

(52) U.S. Cl. 361/91.1

(57) ABSTRACT

An overvoltage protection circuit for preventing voltage and current overload on a telephone line conductor to prevent damage to a SLIC has a first SCR for connecting the conductor to a reference potential and a first trigger operable to switch the SCR from a first, OFF state to a second, ON state. The trigger is voltage-triggered by voltages exceeding a first magnitude on said conductor and current-triggered by voltages exceeding a second magnitude on said conductor, thereby to provide overvoltage protection at two discrete voltage magnitudes.

### BACKGROUND OF THE INVENTION

The present invention relates to the field of overvoltage protection devices and circuits. More specifically, it relates the field of overvoltage protection circuits of the type embodied as integrated circuits, and that are particularly well-suited for use in electrical equipment associated with telephone lines.

In a telephone access network, the electronic circuitry which feeds the telephone line to the subscriber conventionally provides a function known as BORSCHT, which stands for Battery feed, Overvoltage protection, Ringing, Signaling, Coding, Hybrid and Testing. Conventionally, a single integrated circuit (IC) know as a subscriber line interface circuit (SLIC) is provided to carry out the B,S,C and H fuLctions ofBORSCHT, requiring additional circuitry to be provided to perform the functions of overvoltage protection, ringing and testing. In fact, SLICs are increasingly being manufactured to incorporate the ringing and testing functions. Thus, only overvoltage protection needs to be incorporated externally.

### SUMMARY OF THE INVENTION

The present invention aims to provide an improved overvoltage protection circuit that is particularly advantageous for use in electrical equipment associated with telephone lines.

In accordance worth a first preferred embodiment, the present invention provides an overvoltage protection circuit comprising a first switching means for connecting said conductor to a reference potential; and a first trigger means operable to switch said switching means from a first, OFF state to a second, ON state; wherein said first trigger means is voltage-triggered by voltages exceeding a first magnitude on said conductor and current-triggered by voltages exceeding a second magnitude on said conductor, thereby to provide overvoltage protection at two discrete voltage magnitudes.

In a preferred form of the invention said first magnitude is greater than said second magnitude.

Advantageously, said first trigger means comprises a current trigger element for current triggering said first switching means when said voltage on said conductor exceeds said second magnitude and a voltage trigger element for voltage triggering said first switching means when said voltage on said conductor exceeds said first magnitude.

Preferably, said current trigger element is operable to generate a trigger signal in dependence on the current flowing through said conductor, thereby to trigger conduction of said switch in response to said current exceeding a preselected value.

The present invention also provides an overvoltage protection circuit for a conductor comprising a first SCR having a cathode terminal for connection to said conductor, an anode terminal for connection to a reference potential, and a gate; and a first trigger means operable to switch said first SCR from a first, OFF state to a second, ON state; wherein said first trigger means is voltage-triggered by voltages exceeding a first magnitude on said conductor and current-triggered by voltages exceeding a second magnitude on said conductor, thereby to provide overvoltage protection at two discrete voltage magnitudes.

Advantageously, said first magnitude is greater than said second magnitude.

Preferably, said first SCR comprises a current trigger element for current triggering said SCR when said voltage on said conductor exceeds said second magnitude.

Advantageously, said current trigger element is operable to generate a trigger signal in dependence on the current flowing through said conductor, thereby to trigger conduction of said switch in response to said current exceeding a preselected value.

Preferably, said current trigger element is connected between said gate and said cathode terminal.

### BRIEF DESCRIPTION OF THE DRAWINGS

The present invention will now be described, by way of example only, with reference to the accompanying drawings in which:

FIG. 1a is a schematic block diagram of a known overvoltage protection circuit;

FIG. 1b is a diagram of the electrical characteristics of the protection circuit of FIG. 1a;

FIG. 2a is a schematic circuit diagram of a first preferred embodiment of an overvoltage protection circuit according to the invention;

FIG. 2b is a diagram of the electrical characteristics of the protection circuit of FIG. 2a;

FIG. 3 shows a preferred silicon structure for the protection circuit of FIG. 2a;

FIG. 4a is a schematic circuit diagram of a second preferred embodiment of a protection circuit according to the invention;

FIG. 4b is a diagram of the electrical characteristics of the protection circuit of FIG. 4a;

FIG. 5 shows a possible silicon structure for the protection circuit of FIG. 4a;

FIG. 6 is a schematic circuit diagram of a third embodiment of a protection circuit according to the invention;

FIG. 7a is a schematic circuit diagram of a fourth embodiment of a protection circuit according to the invention;

FIG. 7b is diagram of the electrical characteristics of the protection circuit of FIG. 7;

FIG. 8 is a possible silicon structure for the protection circuit of FIG. 7a;

FIG. 9a is a schematic circuit diagram of a fifth embodiment of a protection circuit according to the invention;

FIG. 9b is diagram of the electrical characteristics of the protection circuit of FIG. 9a; and

FIG. 10 is a possible silicon structure for the protection circuit of FIG. 9a.

### DETAILED DESCRIPTION OF THE INVENTION

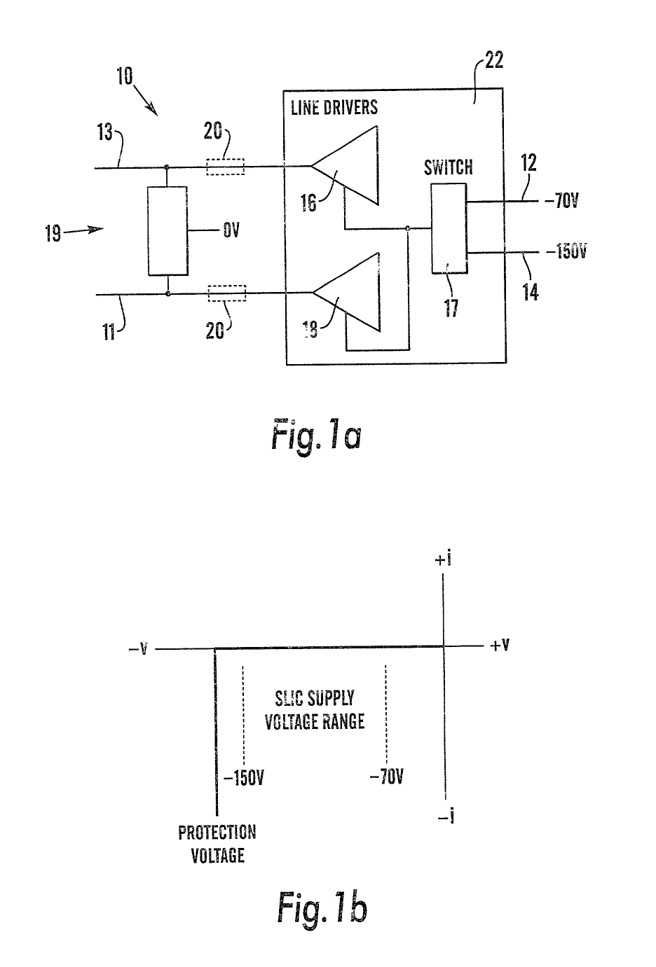

FIG. 1a shows, generally at 10, a conventional SLIC 22 and an associated overvoltage protection circuit 19, of known design, for preventing voltage and current overload on telephone line conductors 11, 13 to prevent damage to the SLIC 22. FIG. 1b shows the electrical characteristics of the protection circuit 19. Since the ringing function requires a higher supply voltage than the negative battery feed to the SLIC, an additional negative voltage supply is provided on the SLIC. Thus, the SLIC has two negative voltage supplies 12, 14 respectively at −70 volts for normal use and at −150 volts for the ringing function. In order to minimise power consumption and dissipation, the two negative voltage supplies are internally switched by a switch 17 on to line driver amplifiers 16, 18, to boost their voltage swing when ringing is required.

Since the voltage supply to the SLIC 22 can be switched between −70 volts and −150 volts, in order to provide adequate protection for the conductor lines 11, 13, the protection circuit 19 must start to limit voltage on the line when the voltage falls below −150 volts. However, this protection is inadequate when the line driver amplifiers are switched to the −70 volts supply, since the line voltage will be allowed to drop to −150 volts before the overvoltage is limited. The voltage-current characteristic of the circuit 19 shown in FIG. 1b illustrates that almost 100 volts of overvoltage will be applied to the line driver amplifiers in this situation. With this level of overvoltage, high and possibly destructive currents can be sourced by the line driver amplifiers 16, 18.

Conventionally, a series resistor 20 is connected directly to each SLIC line driver output in order to limit current flow at these high overvoltages. However, this resistor must be capable of a high power dissipation and consequently, in normal use, generates a substantial drop in line feeding voltage.

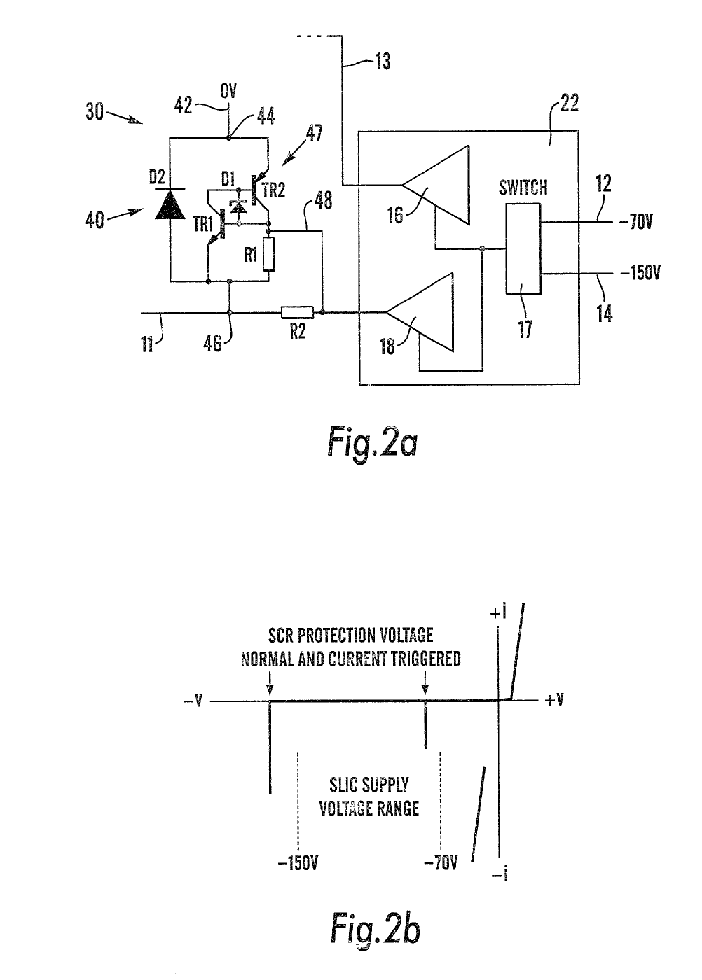

FIG. 2a illustrates a first preferred embodiment of an overvoltage protection circuit 40 according to the present invention which is used to provide protection for the SLIC 22. A separate protection circuit 40 is provided for each line conductor 11, 13. The protection circuits are identical and therefore only one is shown in FIG. 2a for clarity. in this embodiment, the SLIC may be a conventional SLIC as shown in FIG. 1a, for example that manufactured under the trade name Infineon PEB 4266. The two supply voltages, 12, 14 can be alternately switched between the line driver amplifiers 16, 18 by means of a switch 17.

The overvoltage protection circuit 40 is connected between the conductor line 11 and a protective bonding and grounding line (PG) 42. In this embodiment, the PG 42 is represented by ground zero voltage. Since the supply voltage to the SLIC 22 and conductor line 11 is negative, PG 42 actually acts as a current source providing current to the conductor line 11 in order to increase its voltage when an overvoltage occurs.

The protection circuit 40 comprises a protection device 47 in the form of a silicon controlled rectifier (SCR) 47 connected between PG 42 at its anode 44 and to the conductor line 11 at its cathode 46. The SCR 47 is conventional in form and can be represented by the combination of two bipolar transistors TR1, TR2 having two common electrodes. Thus, the anode 44 of the protection circuit 40 is formed by the emitter electrode of the second transistor TR2, and the cathode 46 of the protection circuit 40 is formed by the emitter of the first transistor TR1. The base electrode of each transistor TR1, TR2 is connected to the collector of the other transistor.

In order to provide adequate protection to the conductor line 11, the protection circuit 40 includes a number of other circuit components. Firstly, the base electrode of the first transistor TR1 (which is also the collector electrode of the second transistor TR2) is connected to the conductor line 11 by means of a first resistor R1. Secondly, the base electrode of the first transistor TR1 is also connected to the base electrode of the second transistor TR2 (which is also the collector electrode of the first transistor TR1) by means of an avalanche or zener diode D1. The diode D1 is poled in the same direction as the collector-base diodes of the transistors TR1 and TR2 and exhibits avalanche breakdown when the reverse bias voltage exceeds a predetermined level. In addition, the base electrode of the first transistor TR1 is connected directly to the conductor line I by a short circuit 48 parallel with the resistor R1.

The embodiment of FIG. 2a also includes two further circuit elements. The first of these elements is a conventional semi-conductor diode D2 which is connected in antiparallel with the SCR 47, i.e., diode D2 anode to SCR 47 cathode and diode D2 cathode to SCR 47 anode. A second (optional) element is a second resistance R2 that is connected serially in the conductor line 11.The connection provided by the second resistance R2 is, of course, open circuit if the second resistance R2 is omitted.

FIG. 2b is a diagram of the electrical characteristics of the protection circuit 40 of FIG. 2a. The operation of the circuit of FIG. 2a is described below.

Voltage Triggering

In the ringing mode, the switch 17 operates to connect the −150 volt supply to the line driver 18. The protection circuit 40 is therefore operable to protect the conductor line 11 from any overvoltages which may take the voltage on the conductor line 11 below −150 volts. When the magnitude of the voltage on the conductor line is at −150 volts or less, the SCR 47 of the protection circuit 40 is in an “off” state and is non-conducting.

The base-emitter junction of the second transistor TR2 is forward-biassed, and the base electrode of the second transistor TR2 floats substantially at zero volts. However, since the breakdown voltage of the zener diode D1 has not been exceeded, the base electrode of the first transistor TR1 is held at the voltage of line 11 via the first resistor R1. When an overvoltage occurs on the conductor line 11 which takes the line voltage below −150 volts (i.e. a magnitude greater than 150 volts), the voltage differential between the base electrodes of the transistors TR1 and TR2 i.e., across the zener diode D1) increases. When that differential increases to the breakdown voltage of the zener diode D1, the zener diode D1 breaks down and begins to conduct.

The resulting fall in voltage on the base electrode of the second transistor TR2 causes it to conduct an increasing current. This in turn results in an increase in current flowing through the first resistor R1, increasing the forward voltage across the base-emitter junction of the first transistor TR1 and causing it to begin conducting current. Once both transistors are conducting, regeneration occurs, and current flow through the transistors increases rapidly. The connection between the anode 44 and the cathode 46 of the protection circuit 40, and hence the connection between ground zero and the conductor line 11, is closed. Current therefore flows from ground zero to the conductor line 11, increasing the voltage of the latter. At the same time, the resulting decrease in the voltage drop across the zener diode D1 turns the latter off. The transistors TR1 and TR2 remain fully conducting until such time as the cause of the overvoltage is removed. At this point, the SCR 47 reverts from its conducting, on-state to its nonconducting, off-state condition.

Current Triggering

When not in the ringing mode, the switch 17 switches the −70 volts supply line to the line driver 16. In this mode, the line drivers maintain a voltage bias on the two line conductors 11, 13. Line current flows through resistors R1 and R2 (when present) in parallel. With correctly chosen values for R1 and R2, the voltage developed will be too low to cause current conduction by the first transistor TR1.

However, when an overvoltage occurs on the conductor line 11 which takes the line below −70 volts, substantial line current will flow through the resistors R1, R2. The resulting voltage drop across the resistors causes base current to flow in first transistor TR1. This then causes the second transistor TR2 to conduct current, increasing the base current for second transistor TR2, with the result that both transistors become fully conducting, switching on the SCR 47.

It can be seen that the overvoltage protection circuit of FIG. 2a is able to protect the conductor line 11 from overvoltages at both −70 volts and −150 volts in dependence upon the mode in which the SLIC operates.

The purpose of the diode D2 is to clip any overvoltages which may occur on the conductor line 11 in the opposite direction, i.e., positive polarity overvoltages. When a positive overvoltage occurs, the line driver 18 is likely to try to reduce the positive excursion by sinking current. This current flows through the first resistor R1 (and the second resistor R2, if present), reverse biassing the base-emitter junction of the first transistor TR1. This voltage may be sufficient to damage the first transistor TR1, and therefore the diode D2 is provided to clip this reverse bias voltage. The diode D2 may be external to or integral with the protection circuit 40.

The second resistor R2 may be provided to reduce the temperature sensitivity of the trigger current or to increase the trigger current level. The value of this resistor will be in the region of a few ohms and causes considerably less power and voltage loss than the protection resistor in the prior art circuit of FIG. 1a.

It will be appreciated that, as mentioned above, the conductor line 13 is protected in the same way by an identical protection circuit 40.

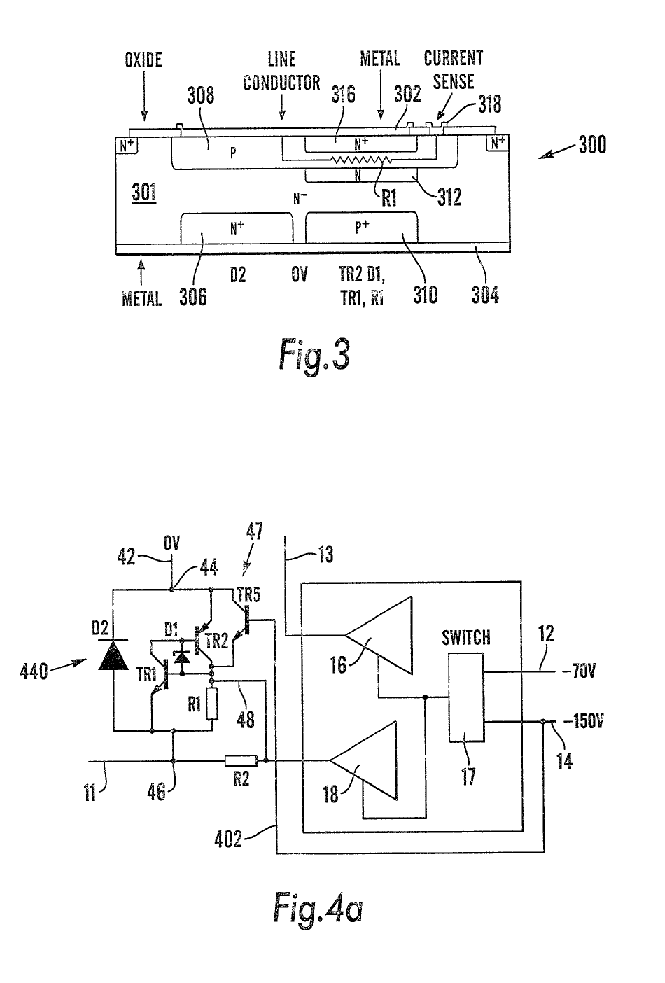

FIG. 3 shows a possible silicon structure 300 for the above described protection circuit 40. It comprises an N⁻ substrate 301 with metallisations 302, 304 respectively formed on the upper and lower surfaces. The lower metallisation 304 forms the anode 44 and the upper metallisation 302 forms the cathode 46 of the protection circuit 40. The diode D2 is formed by N and P doped regions 306, 308 on each side of the N substrate, whilst the SCR 47 and the zener diode D1 are formed by P⁺, N, and N⁺ regions 310, 312 and 316, the P region 308, and the N⁻ substrate 301. The resistor R1 is formed by a path through the P region 308 from a terminal 318 between the N and N⁻ regions to the upper metallisation 302.

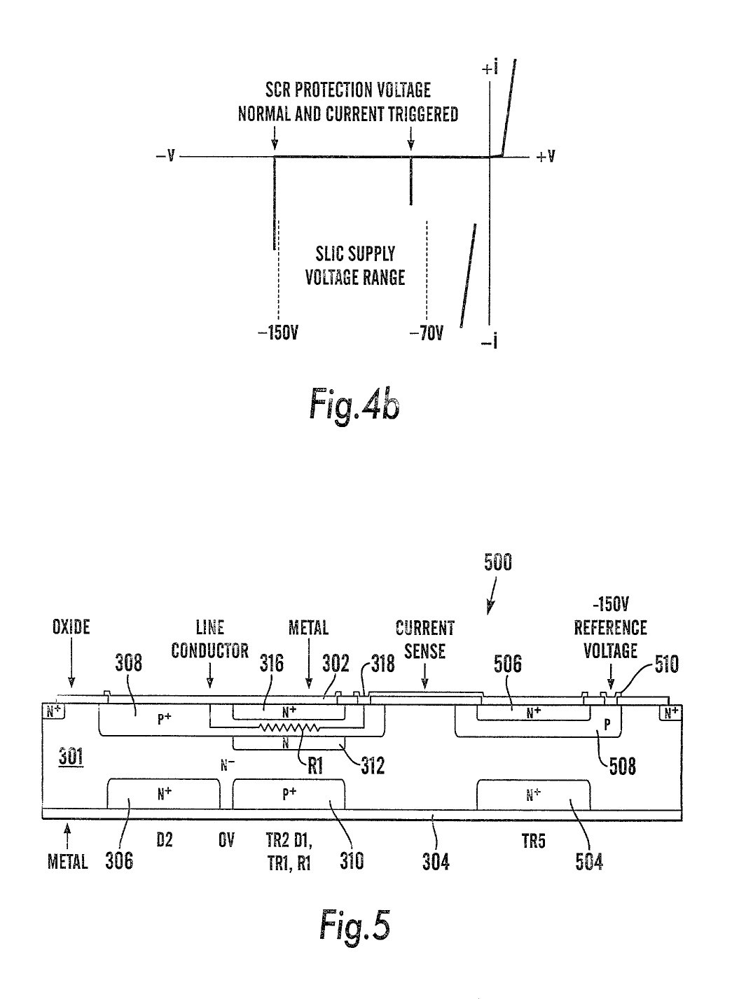

FIG. 4a shows a second preferred embodiment of the protection circuit 440 according to the invention, in which the protection circuit 440 is gated and uses the supply voltage as the protection reference voltage. In this embodiment, the protection circuit 440 has an additional transistor trigger TR5 whose collector is connected to the anode 44 and whose emitter is connected to the collector of the second transistor TR2 and the base electrode of the first transistor TR1. The base electrode of the additional transistor TR5 is connected directly to the −150 volts supply by a line 402. The additional transistor TR5 is connected as an emitter follower.

If the emitter of the additional transistor TR5 is pulled below the −150 v supply level by about 0.7V, the additional transistor TR5 will conduct large amounts of current between the emitter and collector. Since the base of the first transistor TR1 is held close to the −150V supply rail by the emitter of the additional transistor TR5, the first transistor TR1 will start to conduct and will provide base current for transistor TR2. The second transistor TR2 will then start to conduct, switching on the SCR 47. For protection against overvoltages of less than −70 volts, the turn on mechanism is the same as described for FIG. 2a. FIG. 4b is a diagram of the electrical characteristics of the protector circuit of FIG. 4a.

As with FIG. 2a, the line 13 is protected by a protection circuit identical to circuit 440.

FIG. 5 shows a possible silicon structure 500 for the circuit of FIG. 4. The left hand part of the structure is similar to that of FIG. 3, with the additional transistor TR5 being formed by two further N⁺ regions 504, 506, a P region 508, and the − substrate 301. The base region 508 is connected to the −150 volt line through a terminal 510.

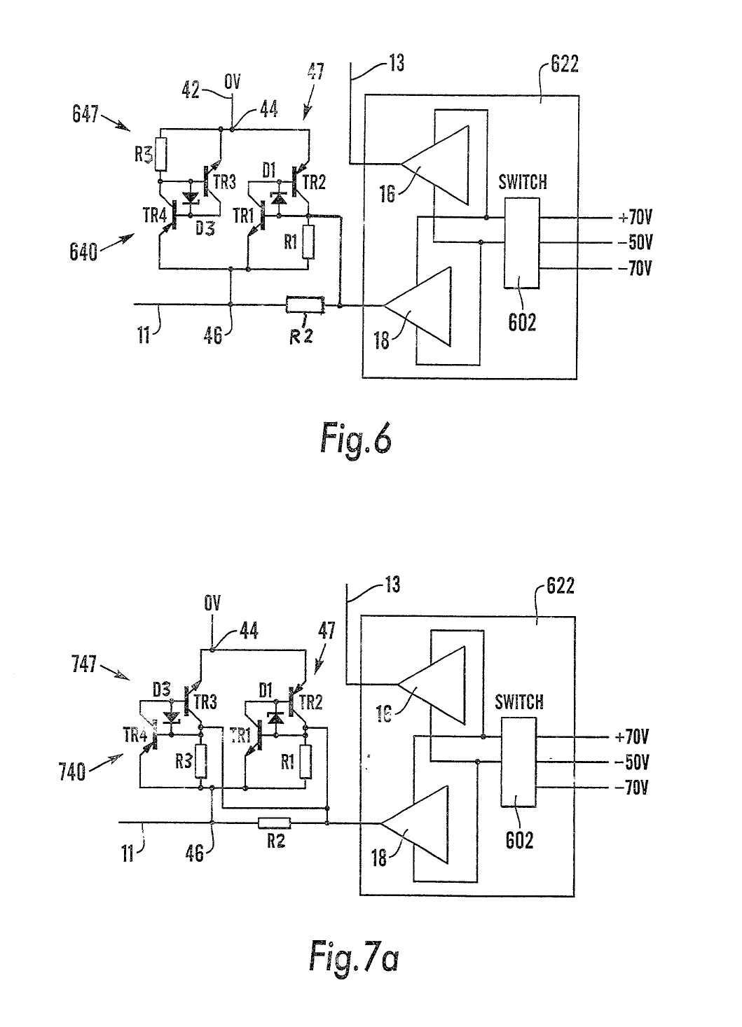

The above described embodiments are applicable particularly but not exclusively, to SLICS of the type shown FIG. 1a, having two negative voltage supplies, one for normal use and one for the ringing function. However, some SLICs are provided with three voltage supplies, and FIG. 6 shows a SLIC 622 with three voltage supplies switched by a switching circuit 602 and protected by a protection circuit 640. In this embodiment, the SLIC has a -50 volt supply which is switched to the line driver amplifiers 16, 18 during normal use and two 70 volt supplies, one of a negative polarity and the other of a positive polarity, for implementation of the ringing function.

In order to protect the SLIC in both the positive and negative polarities, the protection circuit must provide bi-directional switching. This may be achieved by providing two SCRs in an antiparallel arrangement. In effect, the diode D2 of the embodiment of FIG. 2a is replaced by a second SCR 647 in antiparallel with the existing (first) SCR 47, as shown in FIG. 6. However, although the base of the first transistor TR1 can be accessed for current triggering, the base of a third transistor TR3 of the SCR 647 cannot.

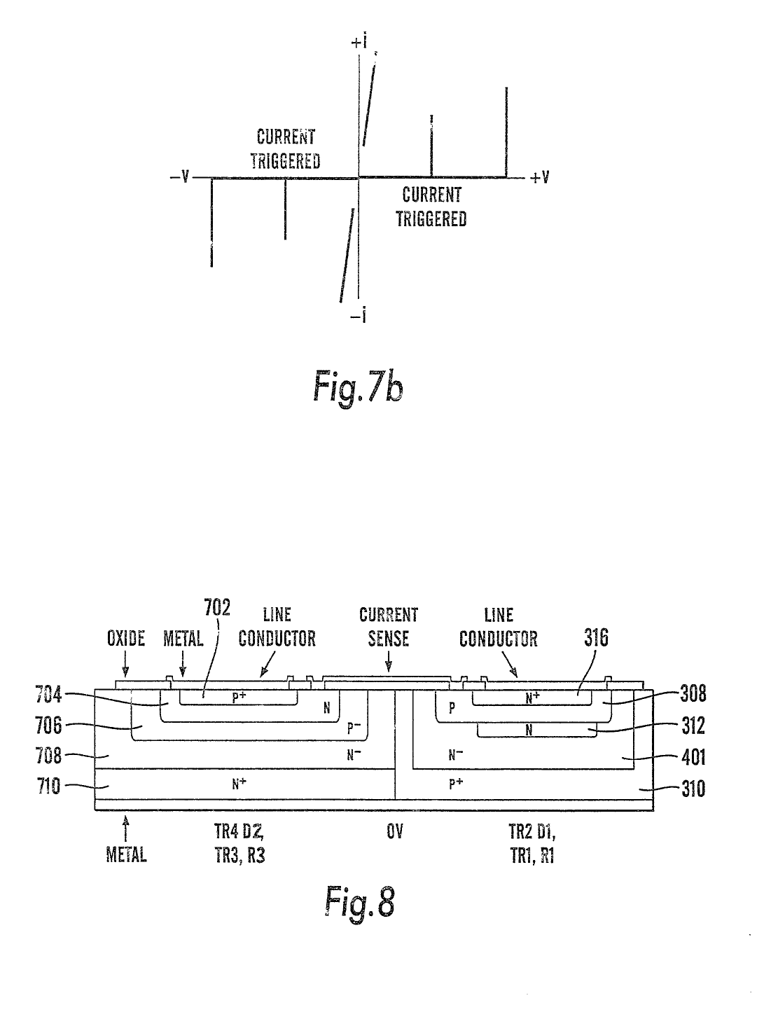

A further preferred embodiment of the protection circuit 740 for use with SLICs provided with three voltage supplies is shown in FIG. 7a. In this embodiment the diode D2 of the FIG. 2a embodiment is replaced by an SCR circuit 747 which is complementary to the first SCR 47. The result is a protection circuit 740 which comprises a complementary SCR pair arrangement (p-gate and n-gate) 47, 747 which allows both voltage and current triggering under overvoltages of both polarities. This circuit will only trigger the current direction corresponding to the overvoltage polarity.

FIG. 7b is a diagram of the electrical characteristics of the protection circuit of FIG. 7a.

A suitable silicon structure for the embodiment of FIG. 7a is illustrated in FIG. 8. The structure on the right hand side of FIG. 8 is similar to the structure of FIG. 3 but with the P⁺ region 310 forming an isolation region for the first SCR 47. The complimentary SCR 747 is formed by the P⁺, N, P⁻, ⁻ and N⁺ regions 702, 704, 706, 708 and 710.

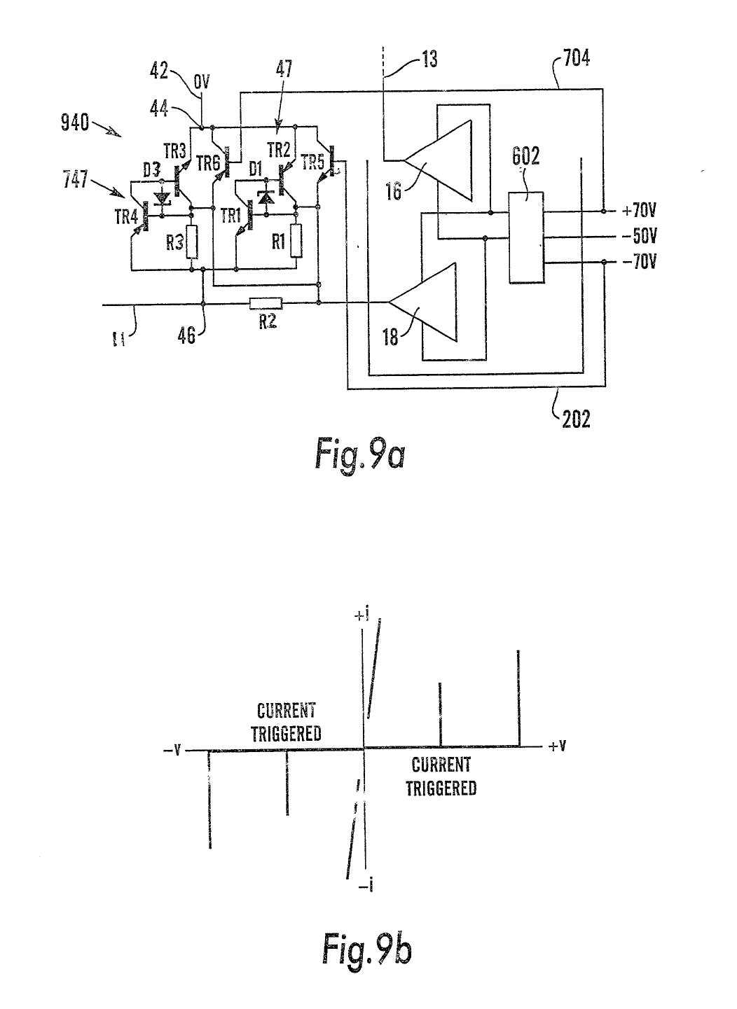

FIG. 9a shows an embodiment of the protection circuit 940 that is for use with SLICs provided with three voltage supplies, which is a modification of the embodiment of FIG. 4a. Here, the diode D2 is replaced by a complementary gated SCR circuit 747. The latter also uses the supply voltage as the protection reference voltage. In this embodiment the protection circuit 940 has an additional transistor TR6 whose collector is connected to the anode 44 and whose emitter is connected to the collector of a third transistor TR3 and the base electrode of a fourth transistor TR4. The base electrode of the additional transistor TR6 is connected directly to the +70 volts supply by a line 704, whilst the base of the transistor TR5 is connected to the −70 volts line by the line 202. The circuit of FIG. 9a is in effect a combination of the circuits of FIGS. 4a and 7a.

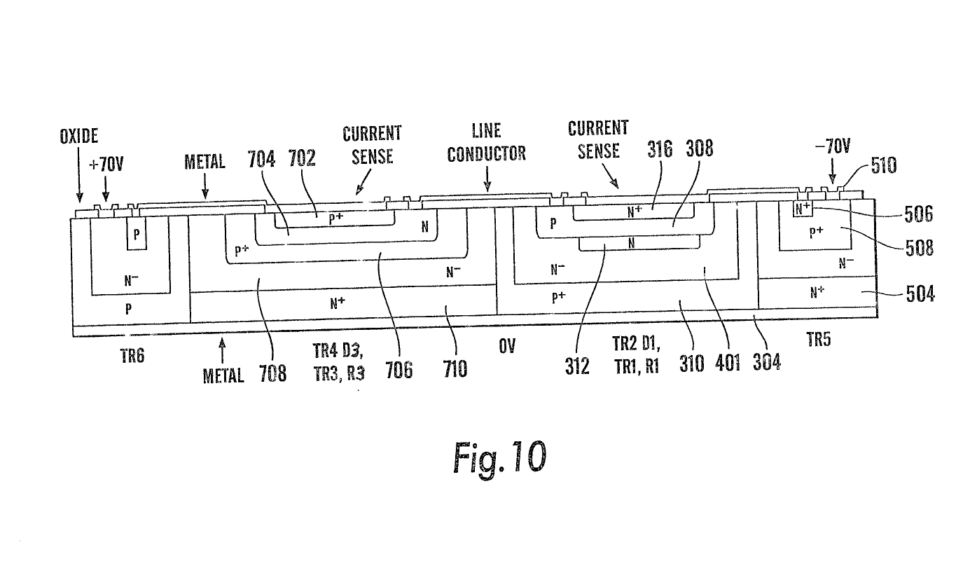

FIG. 9b is a diagram of the electrical characteristics of the protection circuit of FIG. 9a, and FIG. 10 is a possible silicon structure for the protection circuit of FIG. 9a.

Although a number of specific embodiments have been described herein, it will be appreciated that variations and modification s will suggest themselves to those skilled in the pertinent arts. For example, although SCRs have been disclosed as the switching elements in these circuits, other types of switching elements may be found that are suitable, or even preferable, for various applications. Moreover, although the above-described embodiments are best implemented as single integrated circuits, they may also be realized, in whole or in part, with discrete components.

What is claimed is:

1 An overvoltage protection circuit for a conductor, the circuit comprising:
a first switching means for connecting said conductor to a reference potential;
and a first trigger means operable to switch said switching means from a first, OFF state to a second, ON state;
wherein said first trigger means is voltage-triggered by voltages exceeding a first magnitude on said conductor and current-triggered by voltages exceeding a second magnitude on said conductor, thereby to provide overvoltage protection at two discrete voltage magnitudes.

2 A circuit as claimed in claim 1 wherein said first magnitude is greater than said second magnitude.

3 A circuit as claimed in claim 2 wherein said first trigger means comprises a current trigger element for current triggering said first switching means when said voltage on said conductor exceeds said second magnitude.

4 A circuit as claimed in claim 2 wherein said first trigger means comprises a voltage trigger element for voltage triggering said first switching means when said voltage on said conductor exceeds said first magnitude.

5 A circuit as claimed in claim 3 wherein said current trigger element is operable to generate a trigger signal in dependence on the current flowing through said conductor, thereby to trigger conduction of said switching means in response to said current exceeding a preselected value.

6 A circuit as claimed in claim 5 wherein said current trigger element comprises a resistive element.

7 A circuit as claimed in claim 5 wherein said current trigger element comprises first and second parallel resistive elements.

8 A circuit as claimed in claim 6 wherein said current trigger element is connectable in series with said conductor.

9 A circuit as claimed in claim 3 wherein said first trigger means comprises a voltage trigger element for voltage triggering said first switching means when said voltage on said conductor exceeds said first magnitude.

10 A circuit as claimed in claim 9 wherein said current trigger element is operable to generate a trigger signal in dependence on the current flowing through said conductor, thereby to trigger conduction of said switching means in response to said current exceeding a preselected value.

11 An overvoltage protection circuit for a conductor, the circuit comprising:
a first SCR having a cathode terminal for connection to said conductor, an anode terminal for connection to a reference potential, and a gate;
and a first trigger operable to switch said first SCR from a first, OFF state to a second, ON state;
wherein said first trigger is voltage-triggered by voltages exceeding a first magnitude on said conductor and current-triggered by voltages exceeding a second magnitude on said conductor, thereby to provide overvoltage protection at two discrete voltage magnitudes.

12 A circuit as claimed in claim 11 wherein said first magnitude is greater than said second magnitude.

13 A circuit as claimed in claim 12 wherein said first trigger comprises a current trigger element for current triggering said first switching means when said voltage on said conductor exceeds said second magnitude.

14 A circuit as claimed in claim 12 wherein said current trigger element is operable to generate a trigger signal in dependence on the current flowing through said conductor, thereby to trigger conduction of said switching means in response to said current exceeding a preselected value.

15 A circuit as claimed in claim 13 wherein said current trigger element is connected between said gate and said cathode terminal.

16 A circuit as claimed in claim 14 wherein said current trigger element comprises a resistive element.

17 A circuit as claimed in claim 14 wherein said current trigger element comprises first and second parallel resistive elements.

18 A circuit as claimed in claim 16 wherein said current trigger element is connectable in series with said conductor.

19 A circuit as claimed in claim 11 wherein said first trigger comprises a voltage trigger element for voltage triggering said first SCR when said voltage on said conductor exceeds said first magnitude.

20 A circuit as claimed in claim 19 wherein:
said first SCR comprises a first npn transistor device and a second pnp transistor device;
each transistor device has its base electrically connected to the collector of the other device;
the emitter of each device is electrically connected to a respective one of the anode and cathode terminals;
the base of one of the devices is electrically connected to the gat of the SCR;
said voltage trigger element is a zener diode means which is electrically connected across the bases of said devices;
and said zener diode means has a preselected reverse breakdown voltage to trigger conduction of said first SCR in response to said voltage on said conductor exceeding said first magnitude.

21 A circuit as claimed in claim 19 wherein said voltage trigger element is a transistor device connected between said gate and said anode terminal and the base of the transistor device is connected to a preselected reference voltage at said first magnitude.

22 A circuit as claimed in claim 20 wherein said voltage trigger element is a third npn transistor device having its collector connected to the emitter of the second pnp transistor device, its emitter connected to said gate, and its base connected to a preselected reference voltage at said first magnitude.

23 A circuit as claimed in claim 11 further comprising a diode means connected in antiparailel between said anode and cathode terminals.

24 A circuit as claimed in claim 11 further comprising:
a second SCR connected in antiparallel to said first SCR;
and second trigger;
wherein:
said first trigger is voltage triggered by voltages exceeding said first magnitude of a first polarity and said second trigger is voltage triggered by voltages exceeding said first magnitude of the reverse polarity.

25 A circuit as claimed in claim 11 further comprising:
a complementary, second SCR connected in parallel with said first SCR so as to provide a complementary pair of SCRs;
and second trigger operable to switch said first SCR from a first, OFF state to a second, ON state;
wherein:
said first trigger is voltage-triggered by voltages of a first polarity exceeding said first magnitude on said conductor and current-triggered by voltages of said first polarity exceeding said second magnitude on said conductor;
and said second trigger is voltage-triggered by voltages of the reverse polarity exceeding said first magnitude on said conductor and current-triggered by voltages of said reverse polarity exceeding said second magnitude on said conductor;
thereby to provide overvoltage protection at two discrete voltage magnitudes of both polarities.

26 A circuit as claimed in claim 12 wherein said first trigger comprises a current trigger element for current triggering said first switching means when said voltage on said conductor exceeds said second magnitude.

27 A circuit as claimed in claim 26 wherein said current trigger element is operable to generate a trigger signal in dependence on the current flowing through said conductor, thereby to trigger conduction of said switching means in response to said current exceeding a preselected value.
